(19) United States
(12) Patent Application Publication
(10) Pub. No.: US 2022/0185925 A1
(43) Pub. Date: Jun. 16, 2022

(54) SUGAR-BASED, ENVIRONMENTALLY-FRIENDLY SURFACTANTS FOR EMULSION POLYMERIZATION

(71) Applicant: Colonial Chemical, Inc., South Pittsburg, TN (US)

(72) Inventors: David D. Anderson, Chattanooga, TN (US); Robert J. Coots, Chattanooga, TN (US); Robert N. Comber, South Pittsburg, TN (US); Garret Bryant, Rocky Face, GA (US)

(21) Appl. No.: 17/603,335

(22) PCT Filed: Apr. 9, 2020
(86) PCT No.: PCT/US20/27552

§ 371 Date: Oct. 12, 2021

Related U.S. Application Data
(60) Provisional application No. 62/831,605, filed on Apr. 9, 2019.

(51) Int. Cl. C08F 220/18; C09D 5/02; C09D 133/06; C08F 2/28

(52) U.S. Cl. CPC C08F 220/1804; C08F 2/28; C09D 133/06; C09D 5/027

(57) ABSTRACT

A composition for an aqueous emulsion polymerization which comprises at least one derivatized alkyl polyglucoside surfactant in a range of 0.01-10%; water, in a range from 20-80% by weight; at least one monomer for emulsion polymerization making up 20-80% of the emulsion polymerization, and at least one initiator in the range of 0.01-5%; with the derivatized alkylpolyglucosides being polyoxyethylene, ethylene oxide and 1,4-dioxane free.

### PRIOR APPLICATIONS

This application claims benefit to U.S. Patent Application No. 62/831,605, filed Apr. 9, 2019; the contents of which are incorporated herein by reference.

### BACKGROUND OF THE INVENTION

Emulsion polymerization has been used for a number of applications since its development by the Goodyear Tire & Rubber company in the 1920's. It is a process used to synthesize hydrophobic polymers within an aqueous medium. In this process hydrophobic monomers are dispersed into small particles via the use of surfactants. These particles are then introduced to a free radical initiator in order to initiate the polymerization. The final product is an opaque liquid of low viscosity containing polymer particles. This liquid can be further referenced as a latex. The latex has a unique property of forming a polymer film once dried and can have its properties modified to be used in various applications.

Some uses for polymer latexes include latex paints, adhesion promoting primers, adhesives, textile coatings, paper binders, clear coat coating, cement modifiers, water resistant sealers, rheology modifiers, and latexes for various oilfield applications, etc. The latexes used in these applications are made in either a batch, semi-continuous or a continuous-feed process, in which the typical raw materials for a polymer latex are introduced, including but not limited to: water, monomers, surfactants, co-surfactants, and initiators. The choice of monomers used and the reaction conditions, including choice of surfactants, determine the properties of the polymer particles that are formed, as well as the final latex physical properties. Within each respective formulation for each application various other additives are introduced in order to impart a property specific to the individual formulation and application. These additives can include, but are not limited to: a rheology modifier, colorants/pigments, filler minerals, a defoamer, a neutralizing agent, a dispersant, a film formation modifier, a freeze-thaw stabilizer, a wetting agent, a rosin based, terpene phenolic, or hydrocarbon based resin, a crosslinker, etc.

There are several types of surfactants or co-surfactants that are typically used in emulsion polymerization including, but not limited to, anionic surfactants, for example sodium lauryl sulfonate or sodium lauryl sulfate, or nonionic surfactants, for example, nonylphenol ethylates. Examples of the other anionic surfactants used in emulsion polymerization are alkylbenzene sulfonates such as sodium dodecylbenzene sulfonate, a polyoxyethylenealkylether sulfuric acid salt, ammonium polyoxyethylenephenylether sulfonate, polyoxyethylene polyoxypropylene glycol ether sulfuric acid salts, mono- and dialkylphosphate esters, and a so-called reactive emulsifier having a sulfonic acid group or a sulfuric ester group and a polymerizable carbon-carbon unsaturated double bond in its molecule. Examples of other nonionic surfactants are polyoxyethylene alkylethers, polyoxynonylphenylethers, sorbitan aliphatic acid esters, polyoxyethylene aliphatic acid esters, polyoxyethylene-polyoxypropylene block copolymers, and reactive nonionic surfactant having the above-mentioned group and polymerizable carbon-carbon unsaturated double bond in its molecule; cationic surfactants such as, an alkylamine salt and a quaternary ammonium salt; and (modified)polyvinyl alcohol.

While these surfactants work well for the process of emulsion polymerization, they have some limitations. Chiefly among them being renewability, irritation to the end user, and ecotoxicity. A large number of surfactants used in emulsion polymerization, such as, alkyl phenol ethoxylates, alpha olefin sulfonates, dodecyl benzene sulfonates, polyethylene-polypropylene block copolymers, etc, are manufactured from non-renewable petrochemical sources. Others, such as, sodium lauryl sulfate, are produced mainly from renewable resources but are skin irritants that may cause discomfort in the end user. Many surfactants used for this application contain ethoxylated chains in order to increase their effectiveness as emulsifiers. However, the process of ethoxylation uses petrochemical ethylene oxide reducing the surfactants renewability as well as introducing 1,4-dioxane, which is carcinogenic and highly regulated. Likewise, some surfactants used for emulsion polymerization have a high ecotoxicity, such as, alkylphenol ethoxylates. These surfactants are harmful to aquatic organisms, as well as, being suspected to disrupt hormone systems in mammals.

Herein is described a new class of surfactants for emulsion polymerization based on alklypolyglucosides that meet a long-felt need by addressing issues found with the traditional surfactants previously outlined. The surfactants proposed for emulsion polymerization within this patent are derived from natural resources, non-irritating to the end user, safe for the environment, and biodegradable.

### SUMMARY OF VARIOUS EMBODIMENTS OF THE INVENTION

One embodiment of the present invention is a composition for an aqueous emulsion polymerization, comprising derivatized alkyl polyglucosides.

Another embodiment of the present invention is the use of derivatized alkyl polyglucosides surfactants in the process of emulsion polymerization.

Another embodiment of the present invention is the use of derivatized alkyl polyglucosides in the process of emulsion polymerization, including in the manufacture of ASE/HASE type rheology modifiers.

Another embodiment of the present invention is an emulsion polymerization process comprising the use of the surfactants of the present invention.

Another embodiment of the present invention is a method of making a product using the emulsion polymerization process of the present invention.

Another embodiment of the present invention is a method of producing latex paints, comprising the use of surfactants of the present invention.

Another embodiment of the present invention is a paint composition that comprises a surfactant of the present invention.

Another embodiment of the present invention is an adhesive composition that comprises a surfactant of the present invention.

Another embodiment of the present invention is a textile compound composition that comprises a surfactant of the present invention.

Another embodiment of the present invention is a water-resistant sealer composition that comprises a surfactant of the present invention.

Another embodiment of the present invention is an adhesion promoting primer composition that comprises a surfactant of the present invention.

Another embodiment of the present invention is a clear protective, or aesthetic clearcoat composition that comprises a surfactant of the present invention.

Another embodiment of the present invention is composition to be used as an additive for cementitious products, such as, but not limited to, cement, self-levelers, grouts, and mortars that comprises a surfactant of the present invention.

Another embodiment of the present invention is an additive for paper processing, such as, but not limited to, paper binders, or feel modifying additive compositions that comprises a surfactant of the present invention.

Another embodiment of the present invention is a personal care composition that comprises an emulsion polymer that comprises a surfactant of the present invention.

Another embodiment of the present invention is a drug delivery system composition that comprises a surfactant of the present invention.

Another embodiment of the present invention is a solid rubber product composition that comprises an emulsion polymer that also comprises a surfactant of the present invention.

Another embodiment of the present invention is a composition for an aqueous emulsion polymerization that comprises at least one derivatized alkyl polyglucoside surfactant in a range of 0.01-10%; water, in a range from 20-80% by weight; at least one monomer for emulsion polymerization making up 20-80% of the emulsion polymerization; and at least one initiator in the range of 0.01-5%.

In another embodiment of the present invention, the composition is ethylene oxide and 1,4-dioxane free.

In another embodiment of the present invention, the monomer for emulsion polymerization is chosen from acrylic acid, methacrylic acid, butyl acrylate, methyl methacrylate, styrene, butadiene, acrylamide, acrylonitrile, ethyl acrylate, butyl methacrylate, and combinations thereof.

In another embodiment of the present invention, the monomer for emulsion polymerization comprises reactive carbon-carbon double bonds.

In another embodiment of the present invention, the initiator is chosen from sodium persulfate, ammonium persulfate, potassium persulfate, azo-type initiators, peroxides, and combinations thereof.

In another embodiment of the present invention, the peroxide is aqueous hydrogen peroxide.

In another embodiment of the present invention, the azo-type initiator is chosen from 2,2′-azobis(2-amidinopropane)hydrochloride, 4,4′-azobis-cyanovaleric acid and 2,2′-azobis (2-methylbutaneamidoxime) dihydrochloride tetrahydrate.

In another embodiment of the present invention, the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In another embodiment of the present invention, the surfactant is a sodium laurylglucoside hydroxypropylsulfonate surfactant, a sodium decylglucoside hydroxypropylsulfonate surfactant, or a sorbitan oleate decylglucoside cross polymer.

In another embodiment of the present invention, the derivatized polyglucoside surfactant of the present invention comprises a monosaccharide unit, a disaccharide unit, a linker, and a functionalizing agent.

In another embodiment of the present invention, the derivatized polyglucoside surfactant of the present invention comprises a monosaccharide unit, a disaccharide unit, a crosslinking agent, and a functionalizing agent.

In another embodiment of the present invention, the composition further comprises a co-surfactant.

Another aspect of the present invention includes a process for producing a latex. For example, the process may comprise providing an aqueous solution that comprises at least one derivatized alkyl polyglucoside surfactant, water, and at least one initiator; and introducing at least one monomer to the aqueous solution.

In another embodiment of the present invention, latex is for use as a paint, adhesive, primer composition, textile composition, clearcoat composition, water resistant sealer, cementitious product, paper binder, alkyd emulsion, personal care product, or rheology modifier.

In another embodiment of the present invention, the personal care product is a cream, lotion, hair styling product, body wash, facial wash, shampoo, and conditioner.

Another aspect of the present invention is a paint composition that comprises an aqueous latex composition of the present invention.

### DETAILED DESCRIPTION OF THE INVENTION

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently disclosed subject matter.

Unless defined otherwise, all technical and scientific terms used herein have the same meaning as is commonly understood by one of skill in the art to which the invention(s) belong.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which need to be independently confirmed.

The compositions of the present invention are many times mixtures of alkyl polyglucosides, and optionally a linker arm, and optionally a functionalizing agent, and optionally a crosslinking agent, which are often characterized as constitutional isomers. Constitutional isomers are compounds that have the same general empirical formula but differ in their constitution, i.e. in their structure, such that they can have a different sequence of the atoms and/or different bonds. Constitutional isomers are therefore fundamentally different from stereoisomers, which include both enantiomers and diastereomers.

Constitutional isomers are in many cases grouped into functional isomers, skeletal isomers, positional isomers and bonding isomers. In the case of functional isomers and bonding isomers, the compounds can have different reactivity; for example, ethanol comprises a hydroxyl group, whereas the constitutionally isomeric dimethyl ether has an ether group. Skeletal isomers and positional isomers differ in the branching and/or the position of functional groups, such that these constitutional isomers can have essentially the same functionality. The expression “essentially the same functionality” accordingly means that the underlying functional group, i.e., for example, a hydroxyl group, a phenyl ring or an ester group, is present in all constitutional isomers, but does not take account of altered reactivity of these groups as a result of different substitution. For example, there is a measurable difference in the reactivity of 1-n-butanol and tert-butanol owing to the stereochemistry, but the functionality as such is identical. In this connection, however, these measurable differences that are covered by the term “essentially the same functionality” are to be neglected, since both compounds in the present case have a hydroxyl functionality. On the other hand, propyne has one alkyne functionality and propadiene has two alkene functionalities. Alkenes, by comparison with alkynes, have a different functionality in the context of this invention, since they exhibit different acidity, for example. Therefore, propyne, by comparison with propadiene, does not have “essentially the same functionality”.

The mixtures of the present invention have essentially the same functionality. Accordingly, components of the mixture, while constitutional isomers, are not functional isomers, and instead are skeletal isomers and/or positional isomers. That is, the functional group may be in a different position on the same carbon chain or on the same sugar molecule, and have essentially the same functionality.

The compounds of the present invention include alkyl polyglucosides, a class of non-ionic surfactants widely used in a variety of cosmetic, household, and industrial applications. Biodegradable and plant-derived from sugars, these surfactants are usually glucose derivatives (alkyl polyglucosides), and fatty alcohols.

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkyl, aryl, alkoxy, hydroxy, mercapto, amino, alkyl substituted amino, nitro, carboxy, carbanyl, carbanyloxy, cyano, methylsulfonylamino, or halogen, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

The term “surfactant” or “surface active agent” refers to an organic chemical that when added to a liquid changes the properties of that liquid at a surface.

As used herein, the term “substantially free” refers to compositions completely lacking the component or having such a small amount of the component that the component does not affect the effectiveness of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

Embodiments of the present invention are ethylene oxide and 1,4-dioxane free.

Alkyl polyglucosides are complex products made by the reaction of glucose and fatty alcohol. In dealing with the chemistry one talks about degree of polymerization (the so called “d.p.”). In the case of traditional alkyl poluglycosides the d.p. is around 1.4. This means that on average the is 1.4 units of glucose for each alkyl group. The fact of the matter is that the resulting material is a mixture having an average of 1.4.

The specific structure of the product is hard to ascertain completely since many positional isomers are possible, but two examples of structures are as follows:

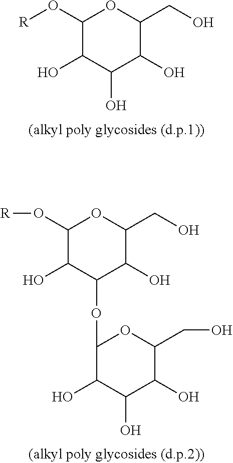

It should be clear that if there is a 50/50 mixture of the d.p. 1 and d.p. 2 product, the resulting analytical data will show that on average there is a d.p. of 1.5. Saying that a molecule has a d.p. of 1.5 does not mean that each molecule has 1.5 glucose units on it.

In one embodiment of the present invention, the surfactant is one that is disclosed in U.S. Pat. No. 6,627,612, incorporated herein by reference; and/or surfactants sold by Colonial Chemical, Inc. under the brand names Suga®Nate and Suga® Fax.

Another embodiment of the present invention is a surfactant disclosed in U.S. Pat. No. 6,958,315, incorporated herein by reference; and/or surfactants sold by Colonial Chemical, Inc. under the brand name Suga®Glycinate.

Another embodiment of the present invention is a surfactant disclosed in U.S. Pat. No. 8,268,766, incorporated herein by reference; and/or surfactants sold by Colonial Chemical, Inc. under the brand name Poly Suga®Mulse.

Another embodiment of the present invention is a surfactant disclosed in U.S. Pat. No. 7,507,399, incorporated herein by reference; and/or surfactants sold by Colonial Chemical, Inc. under the brand names Poly Suga®Quats, PolySuga®Nates, PolySuga®Phos.

Another embodiment of the present invention is a surfactant disclosed in U.S. Pat. No. 7,087,571, incorporated herein by reference; and/or surfactants sold by Colonial Chemical, Inc. under the brand name Suga®Mates.

Another embodiment of the present invention is a surfactant disclosed in U.S. Pat. No. 7,335,627, incorporated herein by reference; and/or surfactants sold by Colonial Chemical, Inc. under the brand name Poly Suga®Carb.

Other embodiments of the present invention include surfactants that are sugar-based sulfonate-, phosphate-, glycinate-, sulfosuccinate-, and carboxylate-containing surfactants derived from alkyl polyglucosides, including those disclosed in U.S. Pat. Nos. 6,627,612; 6,958,315; 7,087,571; 7,507,399 and 7,335,627.

As stated above, the embodiment of the present invention are particularly effective surfactants for use in paint resins. These embodiments are also particularly effecting surfactants for use in the emulsion polymerization of acrylic, mixed styrene-acrylic, mixed vinyl acetate, styrene-butadiene, and mixed vinyl acetate-ethylene resins used in the formulation of paints or other products derived from a polymer latex base, further outlined below. They also work alone or in combination with nonionic, sugar-based sorbitan-ester cross polymers (including those disclosed in U.S. Pat. No. 8,268,766).

The compositions of the present invention include a single embodiment, or mixture, used alone or in combination with an additional embodiment. The additional embodiment can be in the role of a co-surfactant.

Other co-surfactants can be included in the mixtures of the present invention. Examples of the co-surfactants include ionic and nonionic surfactants.

These derivatized alkyl polyglucosides are naturally derived, do not possess polyoxyethylene groups (or contain residual ethylene oxide monomer or 1,4-dioxane), are biodegradable and in many cases have been found to have very low skin and eye irritation.

In one embodiment the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In one embodiment of the present invention, the derivatized polyglucoside surfactant of the present invention comprises a monosaccharide unit, a disaccharide unit, a linker, and a functionalizing agent.

In this regard, a derivatized alkyl polyglucoside composition of the present invention includes the following, as a mixture:

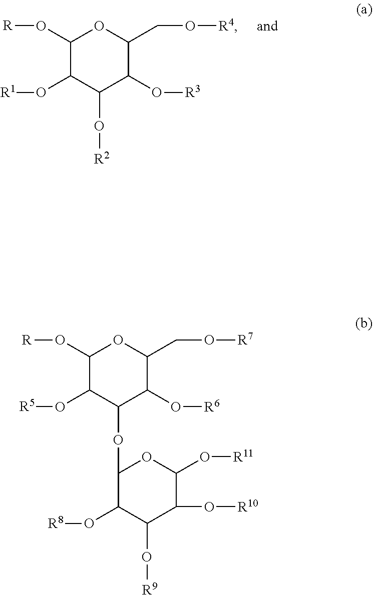

wherein:

R is an alkyl chain having 8 to 22 carbon atoms;

R¹, R², R³, R⁴, R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺

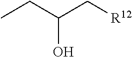

and H, with the proviso that R¹-R¹¹ are not all H;

R¹² is selected from the group consisting of:

—OH, —SO₃⁻M⁺, and —SO₄⁻²M⁺, —O—P(O)—(OM)₂,

—N(CH₃)₂-R^{1A}, —O—C(O)—CH₂—OH(SO₃⁻M⁺)—C(O)—O⁻M⁺,

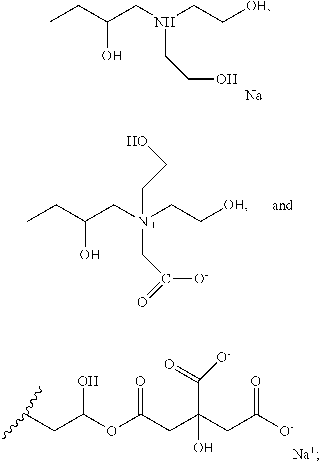

R^{1A} is CH₃—(CH₂)ₙ—;

M is a charge balancing group selected from H, Na, K, or NH₄⁺; and

n is an integer from 0-36;

and positional isomers thereof.

In one embodiment of the present invention, the derivatized polyglucoside surfactant of the present invention comprises a monosaccharide unit, a disaccharide unit, a crosslinking agent, and a functionalizing agent.

In this regard, a derivatized alkyl polyglucoside composition of the present invention includes the following, as a mixture:

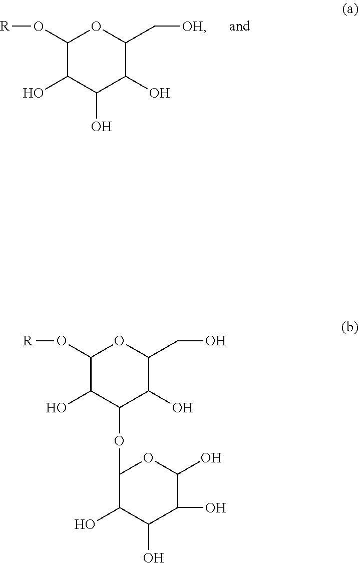

wherein:

R is an alkyl chain having 8 to 22 carbon atoms;

a crosslinking agent of the following formula Cl—CH₂—CH(OH)—CH₂—Cl; and

a functionalizing agent selected from:

(i)

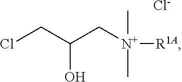

Cl—CH₂—CH(OH)—SO₃M, Cl—CH₂—CH(OH)—SO₄M, Cl—CH₂—CH(OH)—CH₂—OP(O)—(OM)₂, and combinations thereof, wherein

R^{1A} is CH₃(CH₂)ₙ—;

(ii) —Cl—CH₂—C(O)⁻Na⁺, 2-halocarboxylic acid, α, β-unsaturated carboxylic acid, cyclic carboxylic acid anhydride, and combinations thereof;

(iii)

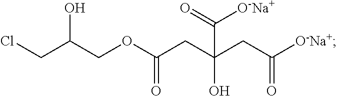

M is a charge balancing group selected from H, Na, K, or NH₄⁺; and

n is an integer from 0-36;

and positional isomers thereof.

Thus, in one embodiment of the present invention is a phosphate and/or sulfonate functionalized alkyl polyglucoside of the following compounds, as a mixture, are useful as surfactants for emulsion polymerization:

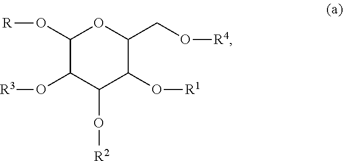

wherein:

R is an alkyl chain having 8 to 22 carbon atoms;

R¹, R², R³, and R⁴ are independently selected from the group consisting of:

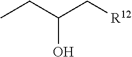

and H, with the proviso that R¹, R², R³, and R⁴ are not all H;

R¹² is selected from the group consisting of:

—OH,—SO₃⁻M⁺, —SO₄⁻²M⁺, and —O—P(O)—(OM)₂;

M is selected from the group consisting of Na, K, NH⁴;

and

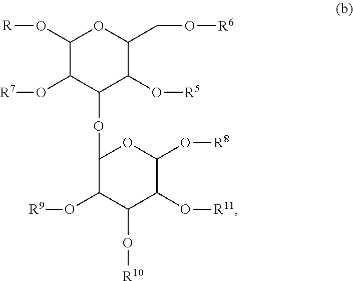

wherein

R⁵, R⁶, R⁷, R⁸, R⁹, R¹⁰, and R¹¹ are independently selected from the group consisting of:

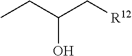

### and H; and

R¹² is selected from the group consisting of:

—OH, —O—P(O)—(OM)₂, —SO₃⁻M⁺, and —SO₄⁻²M⁺, and M is selected from the group consisting of Na, K, NH⁴;

and positional isomers thereof.

These alkyl polyglucoside surfactants are manufactured by Colonial Chemical, Inc., South Pittsburgh, Tenn. 37380. Two examples of which are sodium laurylglucosides hydroxypropylsulfonate (sold under the brand name Suga®Nate 160NC) and sodium decylglucosides hydroxypropylsulfonate (sold under the brand name Suga®Nate 100NC). The alkylpolyglucoside phosphates of the current invention are manufactured by Colonial Chemical, In., South Pittsburgh, Tenn. 37380. An example of which is Sodium Decylglucosides Hydroxypropyl Phosphate, sold under the brand name Suga®Fax D10NC.

These surfactants are synthesized by the methods outlined in U.S. Pat. No. 6,627,612 or their corresponding patents and are generally supplied as clear solutions, 30-50% solids, that are used as is in emulsion polymerization reactions.

The phosphate functionalized alkyl polyglucoside surfactants of this embodiment are also described in U.S. Pat. No. 8,216,994. Thus, phosphate functionalized alkyl polyglucosides of the present invention include those with the following formula:

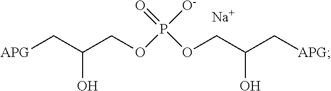

wherein APG is alkyl polyglucoside; and positional isomers thereof. In some embodiments, the alkyl moiety contains about 12 carbon atoms. An example of a suitable phosphate functionalized alkyl polyglucoside includes, but is not limited to, sodium dilaurylglucoside hydroxypropyl phosphate.

The sulfonated functionalized alkyl polyglucoside surfactants of this embodiment are also described in U.S. Pat. No. 8,216,988. Thus, sulfonated functionalized alkyl polyglucosides of the present invention include those with the following formula:

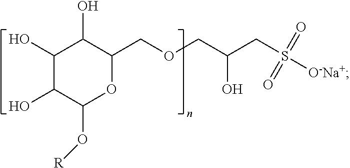

wherein n is between 1 to about 3, and particularly 1.5; and positional isomers thereof. R is an alkyl chain. Examples of suitable sulfonated functionalized alkyl polyglucosides include sodium laurylglucosides, hydroxypropyl sulfonate and sodium declyglucosides hydroxypropyl sulfonate and combinations thereof.

An additional embodiment of the present invention is also a glycinate-modified alkylpolyglucoside surfactants represented by compounds of the following formulae, and positional isomers thereof, as a mixture:

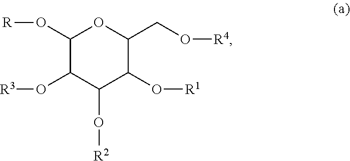

wherein

R is alkyl having 8 to 22 carbon atoms;

R¹, R², R³, and R⁴ are independently selected from

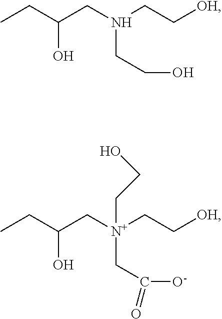 [SMILES: CCC(O)CN(CCO)CCO ; CCC(O)C[N+](CCO)(CCO)CC(=O)[O-]]

and H, with the proviso that R¹, R², R³, and R⁴ are not all H;

and

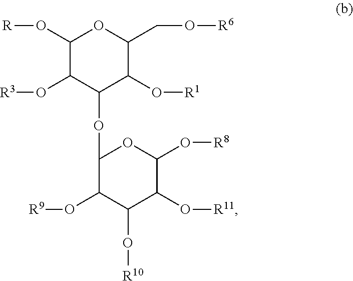

wherein

R is alkyl having 8 to 22 carbon atoms;

R⁵, R⁶, R⁷, R⁸, R⁹, R¹⁰, and R¹¹ are independently selected from

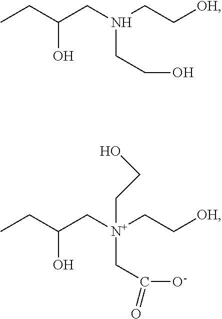 [SMILES: CCC(O)CN(CCO)CCO ; CCC(O)C[N+](CCO)(CCO)CC(=O)[O-]]

and H, with the proviso that R⁵, R⁶, R⁷, R⁸, R⁹, R¹⁰, and R¹¹ are not all H;

and positional isomers thereof.

The alkylpolyglucoside glycinates of the current invention are manufactured by Colonial Chemical, Inc., South Pittsburgh, Tenn. 37380, two examples of which are Sodium Bis-Hydroxyethylglycinate Coco-Glucosides Crosspolymer (sold under the brand name Poly Suga® Glycinate C) and Sodium Bis-Hydroxyethylglycinate Lauryl-Glucosides Crosspolymer (sold under the brand name Poly Suga® Glycinate L).

These surfactants are synthesized by the methods outlined in U.S. Pat. No. 6,958,315 and are generally supplied as clear solutions, 30-50% solids, that are used as is in emulsion polymerization reactions.

An embodiment of the present invention is also cross polymers of alkylpolyglucosides and sorbitan esters as sugar-based nonionic surfactants, represented as compounds of the following formulae, and positional isomers thereof, as a mixture:

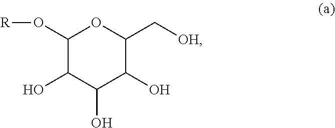

wherein;

R is alkyl having 8 to 22 carbon atoms; and

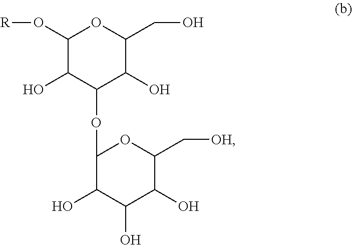

wherein:

R is alkyl having 8 to 22 carbon atoms; and

(c) a sorbitan ester of the following structure:

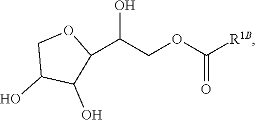

wherein:

R^{1B} is alkyl having 7 to 21 carbons;

a crosslinking agent of the following structure:

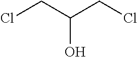

in water; and

optionally a functionalizing agent selected from the group of:

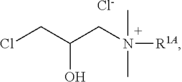

Cl—CH₂—CH(OH)—SO₃M, Cl—CH₂—CH(OH)—SO₄M,
Cl—CH₂—CH(OH)CH₂—OP(O)—(OM)₂, and mixtures thereof;

wherein R^{1A} is CH₃—(CH₂)ₙ—,

n is an integer from 0 to 36;

M is a charge balancing group selected from H, Na, K, or NH₄;

and positional isomers thereof.

The cross polymers of alkylpolyglucosides and sorbitan esters that are the sugar-based nonionic surfactants of the current invention are manufactured by Colonial Chemical, Inc., South Pittsburgh, Tenn. 37380, two examples of which are Poly Suga® Mulse D6 and Poly Suga® Mulse D9, both described as sorbitan oleate decylglucoside cross polymer.

These surfactants are synthesized by the methods outlined in U.S. Pat. No. 8,268,766.

An embodiment of the present invention is also sulfonate-modified, phosphate-modified and cationically modified poly-sugar alkyl polyglucoside surfactants, represented by compounds of the following formulae, as a mixture:

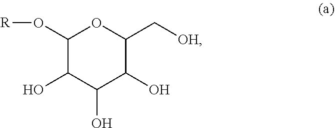

wherein;

R is alkyl having 8 to 22 carbon atoms; and

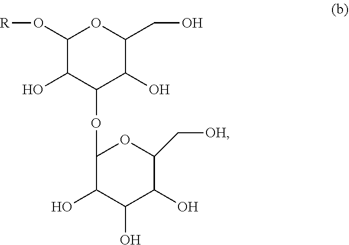

wherein:

R is alkyl having 8 to 22 carbon atoms;

a crosslinker of the following formula: Cl—CH₂—CH(OH)—CH₂—Cl; and

a functionalizing agent selected from:

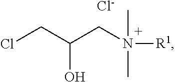

Cl—CH₂—CH(OH)—SO₃M,

Cl—CH₂—CH(OH)—SO₄M,

Cl—CH₂—CH(OH)CH₂—OP(O)—(OM)₂,

and mixtures thereof;

wherein R¹ is CH₃—(CH₂)ₙ—;

n is an integer from 0 to 36;

M is a charge balancing group selected from H, Na, K, or NH₄;

and positional isomers thereof.

These alkyl polyglucosides of the current invention are manufactured by Colonial Chemical, Inc., South Pittsburgh, Tenn. 37380, as shown in U.S. Pat. No. 7,507,399. Examples of these alkyl polyglucosides are: sodium hydroxypropyl phosphate decylglucoside crosspolymer (Poly Suga® Phos 1000P), sodium hydroxypropyl phosphate laurylglucoside crosspolymer (PolySuga® Phos 1200P), Sodium hydroxypropyl phosphate cocoglucoside crosspolymer (PolySuga® Phos 8600P), Sodium hydroxypropyl sulfonate butylglucoside crosspolymer (PolySuga® Nate 40P), Sodium hydroxypropyl sulfonate decylglucoside crosspolymer (PolySuga®Nate 100P), Sodium hydroxypropyl sulfonate laurylglucoside crosspolymer (PolySuga® Nate 160P NC), Polyquaternium-78 (Poly Suga®Quat L-1010P), Polyquaternium-80 (Poly Suga® Quat L-1210P) and Polyquaternium-81 (Poly Suga® Quat S-1201P).

Another description of this embodiment is described in U.S. Pat. No. 8,329,633. Thus, poly quaternary functionalized alkyl polyglucosides of the present invention have the following formula:

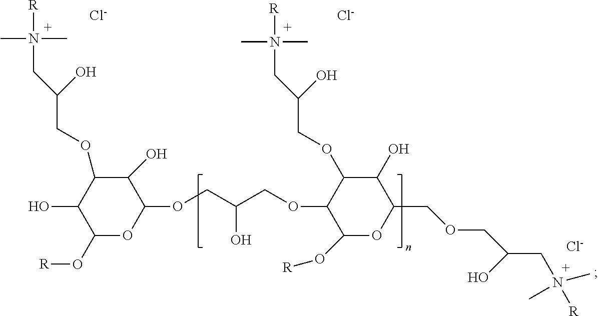

wherein R is an alkyl group having from about 8 to about 22 carbon atoms and n is an integer ranging from 4 to 6; and positional isomers thereof.

Another description of this embodiment is described in U.S. Pat. No. 8,262,805. Thus, poly sulfonate functionalized alkyl polyglucosides of the present invention have the following formula:

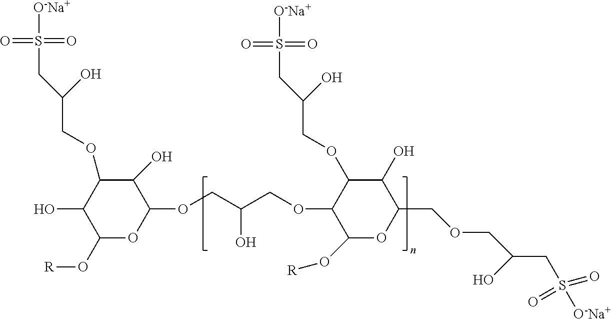

wherein R is an alkyl group having from about 8 to about 22 carbon atoms and n is an integer ranging from 4 to 6; and positional isomers thereof.

Another example of this embodiment is described in U.S. Pat. No. 8,287,659. That is, polyphosphate functionalized alkyl polyglucosides of the following formula:

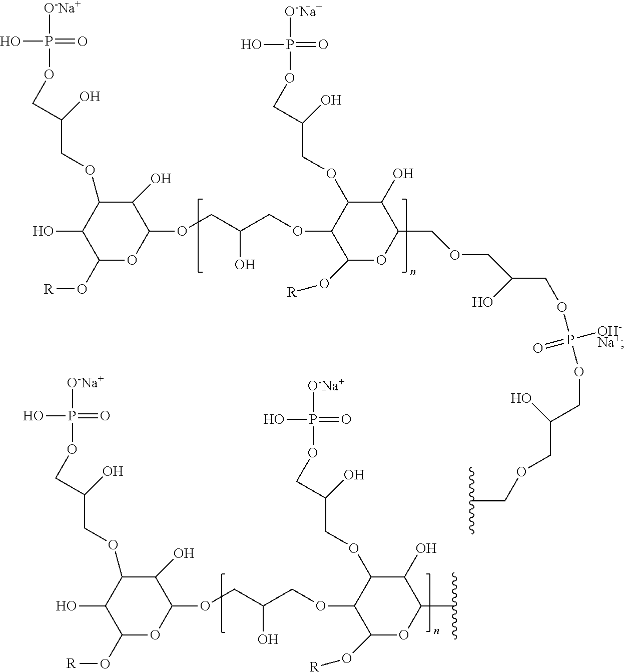

wherein R is an alkyl group having from about 8 to about 22 carbon atoms; and positional isomers thereof.

Another surfactant of the present invention is also described in U.S. Pat. Nos. 8,557,760 and 8,389,457. Quaternary functionalized alkyl polyglucosides of the present invention may have the following representative formula:

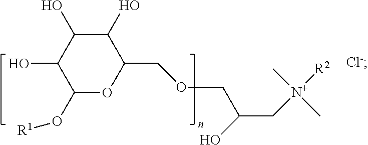

wherein R¹ is an alkyl group having from about 8 to about 22 carbon atoms, and R² is CH₃(CH₂)ₙ, and n is independently an integer from 0-21; and positional isomers thereof. Examples of suitable quaternary functionalized alkyl polyglucosides surfactants include those in the R¹ alkyl moiety contains primarily about 12 carbons, the R² group is CH₃.

Embodiments of the present invention are also sulfosuccinate-modified, alkylpolyglucoside surfactants, represented by compounds of the following formulae, as a mixture:

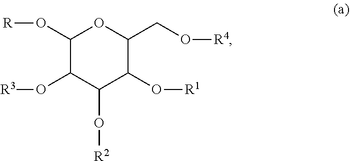

wherein

R is alkyl having 8 to 22 carbon atoms;

R¹, R², R³, and R⁴ are independently selected from —CH₂—CH(OH)—CH₂—R¹², and H,

with the proviso that R¹, R², R³, and R⁴ are not all H;

R¹² is —O—C(O)—CH₂—CH(SO₃ M⁺)—C(O)—O⁻M⁺

M is a charge balancing group selected from H, Na, K, or NH₄;

and

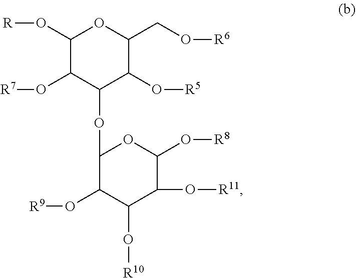

wherein

R is alkyl having 8 to 22 carbon atoms;

R⁵, R⁶, R⁷, R⁸, R⁹, R¹⁰, and R¹¹ are independently selected from —CH₂—CH(OH)—CH₂—R¹², and H,

with the proviso that R⁵, R⁶, R⁷, R⁸, R⁹, R¹⁰, and R¹¹ are not all H;

R¹² is —O—C(O)—CH₂—CH(SO₃ M⁺)—C(O)—O⁻M⁺

M is a charge balancing group selected from H, Na, K, or NH₄;

and positional isomers thereof.

The sulfosuccinate-modified PolySuga® alkylpolyglucosides of the current invention are manufactured by Colonial Chemical, Inc., South Pittsburgh, Tenn. 37380. These surfactants are synthesized by the methods outlined in U.S. Pat. No. 7,087,571 and are generally supplied as clear solutions, 30-50% solids, that are used as is in emulsion polymerization reactions.

Another embodiment of the present invention is carboxymethyl-modified, Poly Suga®-alkylpolyglucoside surfactants, represented by the following components, as a mixture:

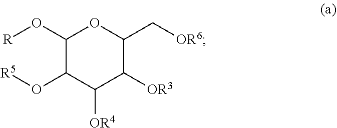

wherein one of R³, R⁴, R⁵, and R⁶ is —CH₂—C(O)—O⁻M⁺ or —C(O)—CH₂—C(O)—O⁻M⁺, with the remaining R groups being H; R is alkyl having 6 to 30 carbon atoms; M is H, Na, or K; and

(b) a 1,3 dicloloro-2-propanol crosslinker;

and positional isomers thereof.

The carboxymethyl-modified Poly Suga® alkyl polyglucosides of the current invention are manufactured by Colonial Chemical, Inc., South Pittsburgh, Tenn. 37380, examples of which are Sodium Maleate Decylglucoside Crosspolymer (Poly Suga®Carb DM), Sodium Maleate Laurylglucoside Crosspolymer (Poly Suga®Carb LM) and Sodium Succinate Laurylglucoside Crosspolymer (Poly Suga®Carb LS).

These surfactants are synthesized by the methods outlined in U.S. Pat. No. 7,335,627 and are generally supplied as clear solutions, 40-60% solids, that are used as is in emulsion polymerization reactions.

Another embodiment of the present invention is a citrate-functionalized polymeric alkylglucoside surfactant, represented by the following components, as a mixture:

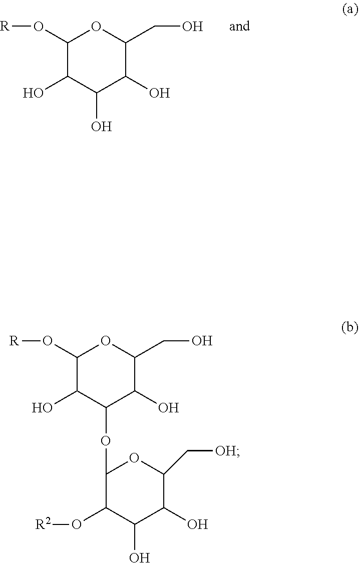

wherein R is an alkyl having 8 to 22 carbons, and R² is:

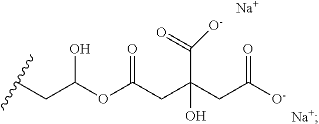

and positional isomers thereof.

The functionalized alkylpolyglucosides of the present invention have found wide application mostly in the personal care market in various cleansing products such as shampoos, body washes and facial washes. However, their use in household, industrial and institutional cleaning has been the subject of a number of patents. The Suga®Quats and Poly Suga®Quats surfactants mentioned above have been patented for use in various hard-surface cleaning applications (outlined in U.S. Pat. Nos. 8,557,760; 8,389,457; 8,329,633; 8,877,703; 10,035,975; and U.S. Pat. No. 9,474,703 issued to Ecolab USA Inc.). The Suga®Nate and Poly Suga®Nate surfactants mentioned above have been also been patented for use in various hard-surface cleaning applications (U.S. Pat. Nos. 8,071,520; 8,216,988; and U.S. Pat. No. 8,262,805 issued to Ecolab USA Inc.). The Poly Suga®Glycinates mentioned above have also been patented for use in various hard-surface cleaning applications (U.S. Pat. No. 8,299,099 issued to Ecolab USA Inc.). The Suga®Fax and Poly Suga®Fax surfactants mentioned above have also been patented for use in various hard-surface cleaning applications (U.S. Pat. Nos. 8,216,994; 8,287,659; and U.S. Pat. No. 8,969,285 issued to Ecolab USA Inc.). The Poly Suga®Mates surfactants mentioned above have been patented for use in various hard-surface cleaning applications of (8,658,584 issued to Ecolab USA Inc.).

As stated above, the present inventors have found the surfactants of the present invention, and combinations thereof, to be useful and beneficial in an emulsion polymerization process. In this embodiment, hydrophobic monomers containing an ethylenically unsaturated, allylic, methallylic, or other double bond capable of undergoing free radical polymerization are dispersed in water as micelles via the use of a surfactant. These Micelles then undergo free radical polymerization by the introduction of water soluble free radical initiators, such as, but not limited to, peroxides, persulfates, or free radicals generated by a redox mechanism. The water-soluble initiator free radicals then either migrate into the polymer micelle and initiate the polymerization, or a free radical formed by the reaction of one or more monomers with an intiator free radical migrate into the polymer micelles and initiate the polymerization. The reaction is carried out using techniques know to the industry as batch, semi-batch, or continuous. The final product is then neutralized to a desired pH using a neutralizing agent of the formulators choosing, most preferably a basic amine or hydroxide salt. The final product may then be preserved using a preservative or biocide of the formulators choosing.

Another embodiment of the present invention is a method of making latex paints, comprising the surfactants of the present invention. In this embodiment, a finished latex which was synthesized using the surfactants of the current invention as emulsifiers is combined with other materials including, but not limited to, a rheology modifier, colorants/pigments, filler minerals, a defoamer, a neutralizing agent, a dispersant, a film formation modifier, a freeze-thaw stabilizer, and a wetting agent.

Another embodiment of the present invention is a method of making adhesives, comprising using the surfactants of the present invention. In this embodiment, a finished latex which was synthesized using the surfactants of the current invention as emulsifiers is combined with other materials including, but not limited to, filler minerals, rosin ester resins, hydrocarbon resins, crosslinking agents, a rheology modifier, a neutralizing agent, a wetting agent, a freeze-thaw stabilizer.

Another embodiment of the present invention is a method of making primer compositions, comprising using the surfactants of the present invention. In this embodiment, a finished latex which was synthesized using the surfactants of the current invention as emulsifiers is combined with other materials including, but not limited to, a rheology modifier, colorants/pigments, filler minerals, a defoamer, a neutralizing agent, a dispersant, a film formation modifier, a freeze-thaw stabilizer, and a wetting agent.

Another embodiment of the present invention is a method of making textile compositions, comprising using the surfactants of the present invention. In this embodiment, a finished latex which was synthesized using the surfactants of the current invention as emulsifiers is combined with other materials including, but not limited to, a rheology modifier, colorants/pigments, filler minerals, a defoamer, a neutralizing agent, a dispersant, a film formation modifier, a freeze-thaw stabilizer, and a wetting agent.

Another embodiment of the present invention is a method of making clearcoat compositions, comprising using the surfactants of the present invention. In this embodiment, a finished latex which was synthesized using the surfactants of the current invention as emulsifiers is used alone, or in combination with other materials including, but not limited to, a rheology modifier, colorants/pigments, filler minerals, a defoamer, a neutralizing agent, a dispersant, a film formation modifier, a freeze-thaw stabilizer, and a wetting agent.

Another embodiment of the present invention is a method of making water resistant sealers, comprising using the surfactants of the present invention. In this embodiment, a finished latex which was synthesized using the surfactants of the current invention as emulsifiers is combined with other materials including, but not limited to, a rheology modifier, colorants/pigments, filler minerals, a defoamer, a neutralizing agent, a dispersant, a film formation modifier, crosslinking agent a freeze-thaw stabilizer, and a wetting agent.

Another embodiment of the present invention is a method of making additives for cementitious products, such as, but not limited to, concrete, grouts, or mortars, comprising using the surfactants of the present invention. In this embodiment, a finished latex which was synthesized using the surfactants of the current invention as emulsifiers is combined with other materials including, but not limited to a rheology modifier, colorants/pigments, filler minerals, a defoamer, a neutralizing agent, a dispersant, a film formation modifier, a freeze-thaw stabilizer, a crosslinker and a wetting agent. The composition within this embodiment is used as an additive to a cementitious admixture to impart a specific property to the admixture, including, but not limited to, improving strength, improving weatherability, improving adhesion, increasing or decreasing hardness, imparting color, modifying porosity, or any number of other modifications to the admixtures properties.

Another embodiment of the present invention is a method of making products used in oilfield applications for varying purposes, comprising using the surfactants of the present invention. In this embodiment, a finished latex which was synthesized using the surfactants of the current invention as emulsifiers is combined is used alone or in combination with other materials to be used in several applications, such as, but not limited to corrosion inhibitors, anti-scalants, lubricants, or any other purpose incorporation an emulsion polymer known to those skilled in the arts.

Another embodiment of the present invention is a method of making paper binders or property modifiers, comprising using the surfactants of the present invention. In this embodiment, a finished latex which was synthesized using the surfactants of the current invention as emulsifiers incorporated into paper products to increase their strength, water resistance, feel, texture, or any other number of properties.

Another embodiment of the present invention is a method of making solid rubber goods, comprising using the surfactants of the present invention. In this embodiment, a finished latex which was synthesized using the surfactants of the current invention as emulsifiers and are incorporated into compositions for solid rubber products. in this process they may be added as liquids prior to drying or curing, may be coagulated and incorporated as a solid, or may be incorporated using any other method known to those skilled in the arts.

Another embodiment of the present invention is a method of making personal care products, comprising using the surfactants of the present invention. In this embodiment, a finished latex which was synthesized using the surfactants of the current invention as emulsifiers is used alone, or combined with other materials for use in the following, but not limited to: creams, lotions, hair styling products, shampoos, and conditioners.

Another embodiment of the present invention is a method of making products used as drug delivery systems, comprising using the surfactants of the present invention. In this embodiment, a finished latex which was synthesized using the surfactants of the current invention as emulsifiers is used alone or in combination with other materials for use in the following, but not limited to, capsule formulations, coatings to control drug release, or any other method of drug delivery known to those skilled in the arts.

Another embodiment of the present invention is an emulsion polymer synthesized specifically for the purpose to be used as a rheology modifier, such as, an ASE/HASE thickener, comprising using the surfactants of the present invention. In this embodiment, a finished latex which was synthesized using the surfactants of the current invention as emulsifiers is formulated using a high level of acidic monomer such as acrylic acid, methacrylic acid, itaconic acid, or any other organic acid with an ethylenically saturated, allylic, methallylic, or any other double bond capable of undergoing free radical polymerization. The Formulation may also contain, in the case of HASE rheology modifiers, monomers used to incorporate hydrophobic side chains into the backbone of the polymer. Some examples of these monomers include, but are not limited to, Behenyl-25-ethoxylate methacrylate, Stearyl-25-ethoxylate methacrylate, and Tristyrly-25-ethoxylate methacrylate. The products within this embodiment works as thickeners when neutralized. The neutralization deprotonates the acidic groups and the resulting residual charges on the polymer repel against one another causing a change in the conformation of the polymer chain, resulting in a thickening effect.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for.

Emulsion polymerizations were carried out in the following type of setup:

All batches were conducted using the same equipment and agitator speeds. The setup consisted of a pre-emulsion tank for monomers, an initiator vessel and a reactor. The pre-emulsion tank consisted of a 2-liter kettle reactor equipped with stirrer and with a 4-joint lid, through which a tygon tubing was fed through a peristaltic pump and connected to the reactor. The agitator speed in the pre-emulsion vessel was maintained at a constant speed of 120 RPM throughout the reaction process. The reactor consisted of a 2-liter kettle, fitted with a 4-joint lid equipped with stirrer and digital thermometer, and was heated by a heating mantle with a digital controller. The agitator was maintained at a speed of 130-140 RPM throughout the reaction and cooling processes. The initiator vessel consisted of a graduated 250 mL addition funnel that was suspended on laboratory support stand. The bottom of the funnel was fitted to small-diameter norprene pump tubing that was fed through a peristaltic pump and fitted to the reactor.

Using the above equipment configuration, some example formulations that were evaluated appear immediately follow:

### Example 1. A Styrene-Acrylic Emulsion Polymer Utilizing Low Levels of Suga®Nate 160NC (Sodium Laurylglucosides Hydroxypropylsulfonate)

| REACTOR CHARGE | Wt. % | Wt. |
|---|---|---|
| WATER | 45.79 | 1377 |
| SUGA ®NATE 160NC | 0.03 | 1 |
| PREEMULSION: | | |
| BUTYL ACRYLATE | 15.7 | 472 |
| STYRENE | 21.95 | 660 |
| DODECYL | 0.47 | 14.1 |
| MERCAPTAN | | |
| ACRYLIC ACID | 1.2 | 36 |
| WATER | 7.85 | 236 |
| SUGA ®NATE 160NC | 0.65 | 19.6 |
| INITIATOR: | | |
| WATER | 5.89 | 177 |
| SODIUM | | |
| PERSULFATE | 0.47 | 14.1 |
| TOTAL: | 100 | 3006.8 |

All reactants (weights in grams) were charged into their respective vessels, the reactor was heated to 180 C, and the monomers and initiators were fed simultaneously into the reactor at feed times of 4 hours and 5.5 hours, respectively. After all reactants had been charged, the temperature was held at 180 C for an additional 30 minutes after which time the reactor was cooled to room temp with constant mixing.

### Example 2. A Styrene-Acrylic Emulsion Polymer Utilizing Low Levels of Suga®Fax D10NC (Sodium Decylglucosides Hydroxypropyl Phosphate)

| REACTOR CHARGE | Wt. % | Wt. |
|---|---|---|
| WATER | 45.79 | 1377 |
| SUGA ®NATE 160NC | 0.03 | 1 |
| PREEMULSION: | | |
| BUTYL ACRYLATE | 15.7 | 472 |
| STYRENE | 21.95 | 660 |
| DODECYL MERCAPTAN | 0.47 | 14.1 |
| ACRYLIC ACID | 1.2 | 36 |
| WATER | 7.85 | 236 |
| SUGA ®NATE 160NC | 0.65 | 19.6 |
| INITIATOR: | | |
| WATER | 5.89 | 177 |
| SODIUM PERSULFATE | 0.47 | 14.1 |
| TOTAL: | 100 | 3006.8 |

All reactants (weights in grams) were charged into their respective vessels, the reactor was heated to 180 C, and the monomers and initiators were fed simultaneously into the reactor at feed times of 4 hours and 5.5 hours, respectively. After all reactants had been charged, the temperature was held at 180 C for an additional 30 minutes after which time the reactor was cooled to room temp with constant mixing.

### Example 3. An Acrylic Emulsion Polymer Utilizing Poly Suga®Glycinate C(Sodium Bis-Hydroxyethylglycinate Coco-Glucosides Crosspolymer)

| REACTOR: | MASS (g) | PERCENT |
|---|---|---|
| WATER | 612.5 | 34.50 |
| SODIUM PERSULFATE | 0.77 | 0.04 |
| POLY SUGA ®GLYCINATE C | 0.51 | 0.03 |
| PRE-EMULSION: | | |
| METHYL METHACRYLATE | 515 | 29.01 |
| METHACRYLIC ACID | 15.45 | 0.87 |
| ACRYLIC ACID | 15.45 | 0.87 |
| BUTYL ACRYLATE | 219.98 | 12.39 |
| WATER | 144.25 | 8.13 |
| POLY SUGA ®GLYCINATE C | 17.7 | 1.00 |
| INITIATOR: | | |
| WATER | 229.77 | 12.94 |
| SODIUM PERSULFATE | 3.81 | 0.21 |
| TOTAL: | 1775.19 | 100.00 |

All reactants (weights in grams) were charged into their respective vessels, the reactor was heated to 180 C, and the monomers and initiators were fed simultaneously into the reactor at feed times of 5 hours and 5.5 hours, respectively. After all reactants had been charged, the temperature was held at 180 C for an additional 30 minutes after which time the reactor was cooled to room temp with constant mixing.

### Example 4. An Acrylic Emulsion Polymer Utilizing Combination of Poly Suga®Mulse D9 (Sorbitan Oleate Decylglucoside Crosspolymer) and C14-16 Alpha Olefin Sulfonate

| REACTOR: | MASS (g) | PERCENT |
|---|---|---|
| WATER | 165 | 22.21 |
| SODIUM PERSULFATE | 0.35 | 0.05 |
| C14-16 ALPHA OLEFIN | 0.2 | 0.03 |
| SULFONATE | | |
| PRE-EMULSION: | | |
| WATER | 47 | 6.33 |
| C14-16 ALPHA OLEFIN | 7.3 | 0.98 |
| SULFONATE | | |
| POLY SUGA ®MULSE D9 | 7.3 | 0.98 |
| METHYL METHACRYLATE | 177.95 | 23.95 |
| BUTYL ACRYLATE | 210.52 | 28.34 |
| ACRYLIC ACID | 15 | 2.02 |
| INITIATOR: | | |
| WATER | 110 | 14.81 |
| SODIUM PERSULFATE | 2.25 | 0.30 |
| TOTAL: | 742.87 | 100.00 |

All reactants (weights in grams) were charged into their respective vessels, the reactor was heated to 180 C, and the monomers and initiators were fed simultaneously into the reactor at feed times of 5 hours and 5.5 hours, respectively. After all reactants had been charged, the temperature was held at 180 C for an additional 30 minutes after which time the reactor was cooled to room temp with constant mixing.

### Example 5. An Acrylic Emulsion Polymer Utilizing a 70/30 Blend of Suga®Nate 160NC (Sodium Laurylglucosides Hydroxypropyl Sulfonate) and C14-16 Alpha Olefin Sulfonate

| REACTOR: | MASS (g) | PERCENT |
|---|---|---|
| WATER | 165 | 22.21 |
| SODIUM PERSULFATE | 0.35 | 0.05 |
| C14-16 ALPHA OLEFIN | 0.2 | 0.03 |
| SULFONATE | | |
| PRE-EMULSION: | | |
| WATER | 47 | 6.33 |
| C14-16 ALPHA OLEFIN | 4.38 | 0.59 |
| SULFONATE | | |
| SUGA ®NATE 160NC | 10.22 | 1.38 |
| METHYL METHACRYLATE | 177.95 | 23.95 |
| BUTYL ACRYLATE | 210.52 | 28.34 |
| ACRYLIC ACID | 15 | 2.02 |
| INITIATOR: | | |
| WATER | 110 | 14.81 |
| SODIUM PERSULFATE | 2.25 | 0.30 |
| TOTAL: | 742.87 | 100.00 |

All reactants (weights in grams) were charged into their respective vessels, the reactor was heated to 180 C, and the monomers and initiators were fed simultaneously into the reactor at feed times of 5 hours and 5.5 hours, respectively. After all reactants had been charged, the temperature was held at 180 C for an additional 30 minutes after which time the reactor was cooled to room temp with constant mixing.

### Example 6. A Styrene-Acrylic Emulsion Polymer Utilizing Low Levels of Poly Suga®Nate 1001³ (Sodium Hydroxypropylsulfonate Decylglucoside Crosspolymer)

| REACTOR: | MASS (g) | PERCENT |
|---|---|---|
| WATER | 165 | 22.18 |
| SODIUM PERSULFATE | 0.35 | 0.05 |
| C14-16 ALPHA OLEFIN | 0.2 | 0.03 |
| SULFONATE | | |
| PRE-EMULSION: | | |
| WATER | 47 | 6.32 |
| C14-16 ALPHA OLEFIN | 7.3 | 0.98 |
| SULFONATE | | |
| POLY SUGA ®NATE 100P | 7.3 | 0.98 |
| STYRENE | 185.52 | 24.94 |
| BUTYL ACRYLATE | 202.95 | 27.28 |
| ACRYLIC ACID | 15 | 2.02 |
| INITIATOR: | | |
| WATER | 110 | 14.79 |
| SODIUM PERSULFATE | 3.25 | 0.44 |
| TOTAL: | 743.87 | 100.00 |

All reactants (weights in grams) were charged into their respective vessels, the reactor was heated to 180 C, and the monomers and initiators were fed simultaneously into the reactor at feed times of 5 hours and 5.5 hours, respectively. After all reactants had been charged, the temperature was held at 180 C for an additional 30 minutes after which time the reactor was cooled to room temp with constant mixing.

### Example 7. A Basic Paint Formulation was Made Using the Latex from Example 3

The formulation is as follows:

| MATERIAL | MASS (g) | PERCENT |
|---|---|---|
| WATER | 150 | 25.69 |
| LOW MOLECULAR WEIGHT | 1.25 | 0.21 |
| POLYACRYLIC ACID | | |
| SILICONE DEFOAMER | 0.85 | 0.15 |
| CALCIUM CARBONATE | 80 | 13.70 |
| TITANIUM DIOXIDE | 125 | 21.41 |
| PIGMENT DISPERSION | 3.2 | 0.55 |
| EXAMPLE LATEX 3 | 200 | 34.26 |
| RHEOLOGY MODIFIER | 4.86 | 0.83 |
| WETTING AGENT | 4.71 | 0.81 |
| TEXANOL ® | 9.48 | 1.62 |
| POLYMERIC DEFOAMER | 0.85 | 0.15 |
| AMMONIUM HYDROXIDE | 3.63 | 0.62 |
| TOTAL: | 583.83 | 100 |

The first six ingredients were added in order under high shear. Once additions were complete the mixture was maintained at high shear for thirty minutes. Shear forces were reduced and the remaining ingredients were added in order under mild agitation. Once additions were complete the mixture was mixed under mild agitation for 30 more minutes.

TABLE 1

| | | | VIS- | SURFACE | |
|---|---|---|---|---|---|
| SAMPLE | % | | COSITY | TENSION | COAGU- |
| ID | SOLIDS | pH | (cPs) | (dynes/cm) | LATION |
| EXAMPLE | 44.67 | 6.95 | 31 | 41.15 | 0.31 g/l |
| LATEX 1 | | | | | |
| EXAMPLE | 44.74 | 7.05 | 38 | 43.5 | 0.41 g/l |
| LATEX 2 | | | | | |
| EXAMPLE | 44.92 | 7 | 32 | 40.7 | 0.13 g/l |
| LATEX 3 | | | | | |
| EXAMPLE | 54.6 | 5.03 | 235 | 41.15 | 0.74 g/l |
| LATEX 4 | | | | | |
| EXAMPLE | 54.4 | 5 | 250 | 41.7 | 1.11 g/l |
| LATEX 5 | | | | | |
| EXAMPLE | 54.53 | 7.02 | 275 | 42.3 | 0.93 g/l |
| LATEX 6 | | | | | |
| EXAMPLE | 52.16 | 8.21 | 1100 | 31.62 | N/A |
| PAINT | | | | | |
| FORMU- | | | | | |
| LATION | | | | | |

As used herein, the singular forms “a,” “an” and “the” include plural referents unless the context clearly dictates otherwise. Thus, for example, reference to “a surfactant” includes mixtures of two or more such surfactants.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture. Compounds described herein can contain one or more asymmetric centers and, thus, potentially give rise to diastereomers and optical isomers. Unless stated to the contrary, the present invention includes all such possible diastereomers as well as their racemic mixtures, their substantially pure resolved enantiomers, all possible geometric isomers, and pharmaceutically acceptable salts thereof. Mixtures of stereoisomers, as well as isolated specific stereoisomers, are also included. During the course of the synthetic procedures used to prepare such compounds, or in using racemization or epimerization procedures known to those skilled in the art, the products of such procedures can be a mixture of stereoisomers. Additionally, unless expressly described as “unsubstituted”, all substituents can be substituted or unsubstituted.

The invention thus being described, it will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only.

1. A composition for an aqueous emulsion polymerization which comprises:
a. at least one derivatized alkyl polyglucoside surfactant in a range of 0.01-10%;
b. water, in a range from 20-80% by weight;
c. at least one monomer for emulsion polymerization making up 20-80% of the emulsion polymerization
d. at least one initiator in the range of 0.01-5%.

2. The composition of claim 1, wherein the composition is ethylene oxide and 1,4-dioxane free.

3. The composition of claim 1, wherein the monomer for emulsion polymerization is chosen from acrylic acid, methacrylic acid, butyl acrylate, methyl methacrylate, styrene, butadiene, acrylamide, acrylonitrile, ethyl acrylate, vinyl acetate, methyl acrylate, 2-ethylhexyl acrylate, butyl methacrylate, and combinations thereof.

4. The composition of claim 1, wherein the monomer for emulsion polymerization comprises reactive carbon-carbon double bonds.

5. The composition of claim 1, wherein the initiator is chosen from sodium persulfate, ammonium persulfate, potassium persulfate, azo-type initiators, peroxides, and combinations thereof.

6. The composition of claim 5, wherein the peroxide is aqueous hydrogen peroxide

7. The composition of claim 5, wherein the azo-type initiator is chosen from 2,2′-azobis(2-amidinopropane)hydrochloride, 4,4′-azobis-cyanovaleric acid and 2,2′-azobis (2-methylbutaneamidoxime) dihydrochloride tetrahydrate.

8. The composition of claim 1, wherein the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

9. The composition of claim 1, wherein the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

10. The composition of claim 1, wherein the derivatized polyglucoside surfactant of the present invention comprises a monosaccharide unit, a disaccharide unit, a linker, and a functionalizing agent.

11. The composition of claim 1, wherein the surfactant is a sodium laurylglucoside hydroxypropylsulfonate surfactant, a sodium decylglucoside hydroxypropylsulfonate surfactant, or a sorbitan oleate decylglucoside cross polymer.

12. The composition of claim 1, wherein the derivatized polyglucoside surfactant of the present invention comprises a monosaccharide unit, a disaccharide unit, a crosslinking agent, and a functionalizing agent.

13. The composition of claim 1, wherein the derivatized alkyl polyglucoside surfactant is a composition that includes the following, as a mixture: 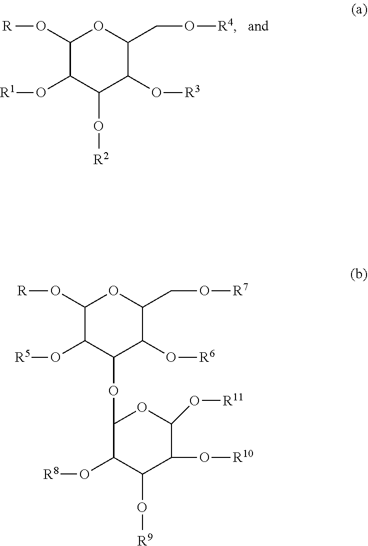
wherein:
R is an alkyl chain having 8 to 22 carbon atoms;
R¹, R², R³, R⁴, R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺ 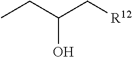
and H, with the proviso that R¹-R¹¹ are not all H;
R¹² is selected from the group consisting of:
—OH, —SO₃⁻M⁺, and —SO₄⁻²M⁺, —O—P(O)—(OM)₂,
—N(CH₃)₂-R^{1A}, —O—C(O)—CH₂—OH(SO₃⁻M⁺)—C(O)—O⁻M⁺, 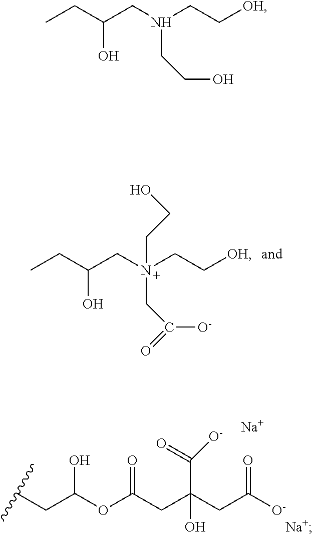
R^{1A} is CH₃—(CH₂)ₙ—;
M is a charge balancing group selected from H, Na, K, or NH₄⁺; and
n is an integer from 0-36;
and positional isomers thereof.

14. The composition of claim 1, wherein the derivatized alkyl polyglucoside surfactant is a composition that includes the following, as a mixture: 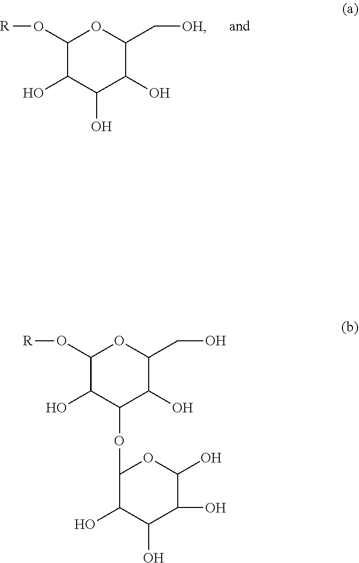
wherein:
R is an alkyl chain having 8 to 22 carbon atoms;
a crosslinking agent of the following formula Cl—CH₂—CH(OH)—CH₂—Cl; and
a functionalizing agent selected from:
(i) 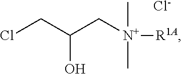
Cl—CH₂—CH(OH)—SO₃M, Cl—CH₂—CH(OH)—SO₄M, Cl—CH₂—CH(OH)—CH₂—OP(O)—(OM)₂, and combinations thereof, wherein
R^{1A} is CH₃(CH₂)ₙ—;
(ii) —Cl—CH₂—C(O)—O—⁻Na⁺, 2-halocarboxylic acid, α, β-unsaturated carboxylic acid, cyclic carboxylic acid anhydride, and combinations thereof;
(iii) 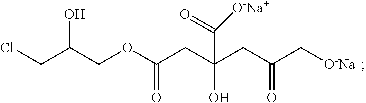
M is a charge balancing group selected from H, Na, K, or NH₄⁺; and
n is an integer from 0-36;
and positional isomers thereof.

15. The composition of claim 1, wherein the functionalized alkyl polyglucoside surfactant is a composition that includes the following, as a mixture: 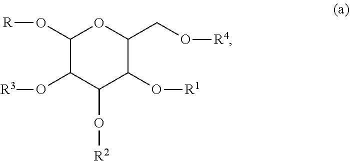
wherein:
R is an alkyl chain having 8 to 22 carbon atoms;
R¹, R², R³, and R⁴ are independently selected from the group consisting of: 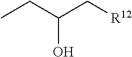
and H, with the proviso that R¹, R², R³, and R⁴ are not all H;
R¹² is selected from the group consisting of:
—OH, —SO₃⁻M⁺, —SO₄⁻²M⁺, and —O—P(O)—(OM)₂;
M is selected from the group consisting of Na, K, NH⁴;
and 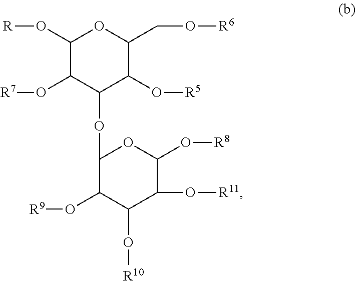
wherein
R⁶, R⁷, R⁸, R⁹, R¹⁰, and R¹¹ are independently selected from the group consisting of: 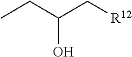
and H; and
R¹² is selected from the group consisting of:
—OH, —O—P(O)—(OM)₂, —SO₃⁻M⁺, and —SO₄⁻²M⁺, and M is selected from the group consisting of Na, K, NH⁴;
and positional isomers thereof.

16. The composition of claim 1, wherein the functionalized alkyl polyglucoside surfactant is a composition that includes the following compound: 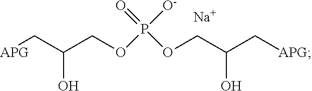
wherein APG is alkyl polyglucoside; and positional isomers thereof.

17. The composition of claim 1, wherein the functionalized alkyl polyglucoside surfactant is a composition that includes the following compound: 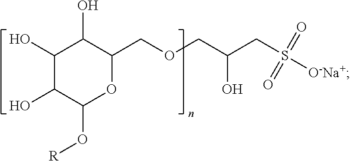
wherein n is between 1 to about 3, and particularly 1.5;
R is an alkyl chain;
and positional isomers thereof.

18. The composition of claim 1, wherein the functionalized alkyl polyglucoside surfactant is a composition that includes the following, as a mixture: 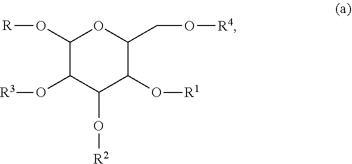
wherein
R is alkyl having 8 to 22 carbon atoms;
R¹, R², R³, and R⁴ are independently selected from 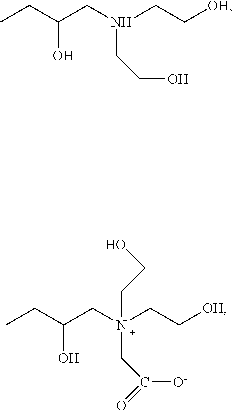
and H, with the proviso that R¹, R², R³, and R⁴ are not all H;
and 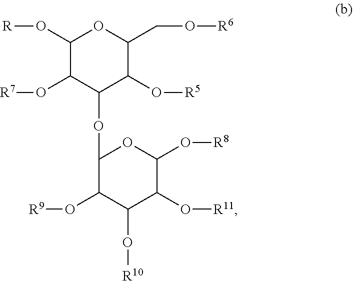
wherein
R is alkyl having 8 to 22 carbon atoms;
R⁵, R⁶, R⁷, R⁸, R⁹, R¹⁰, and R¹¹ are independently selected from 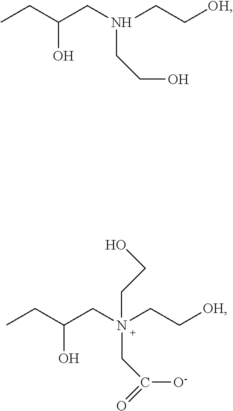
and H, with the proviso that R⁵, R⁶, R⁷, R⁸, R⁹, R¹⁰, and R¹¹ are not all H;
and positional isomers thereof.

19. The composition of claim 1, wherein the functionalized alkyl polyglucoside surfactant is a composition that includes the following, as a mixture: 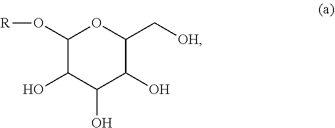
wherein;
R is alkyl having 8 to 22 carbon atoms; and 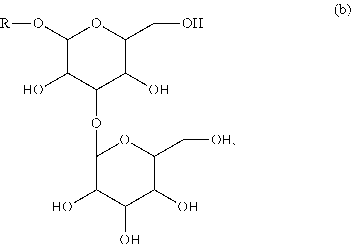
wherein:
R is alkyl having 8 to 22 carbon atoms; and
(c) a sorbitan ester of the following structure: 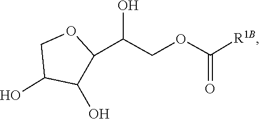
wherein:
R^{1B} is alkyl having 7 to 21 carbons;
a crosslinking agent of the following structure: 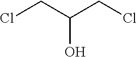
in water; and optionally a functionalizing agent selected from the group of: 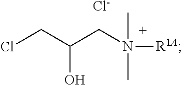
Cl—CH₂—CH(OH)—SO₃M;
Cl—CH₂—CH(OH)—SO₄M;
Cl—CH₂—CH(OH)CH₂—OP(O)—(OM)₂;
and mixtures thereof;
wherein R^{1A} is CH₃—(CH₂)ₙ—;
n is an integer from 0 to 36;
M is a charge balancing group selected from H, Na, K, or NH₄;
and positional isomers thereof.

20. The composition of claim 1, wherein the functionalized alkyl polyglucoside surfactant is a composition that includes the following, as a mixture: 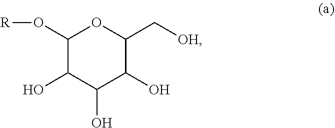
wherein;
R is alkyl having 8 to 22 carbon atoms; and 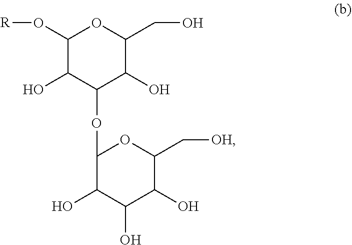
wherein:
R is alkyl having 8 to 22 carbon atoms;
a crosslinker of the following formula: Cl—CH₂—CH(OH)—CH₂—Cl; and
a functionalizing agent selected from: 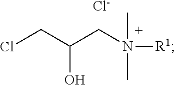
Cl—CH₂—CH(OH)—SO₃M;
Cl—CH₂—CH(OH)—SO₄M;
Cl—CH₂—CH(OH)CH₂—OP(O)—(OM)₂;
and mixtures thereof;
wherein R¹ is CH₃—(CH₂)ₙ—;
n is an integer from 0 to 36;
M is a charge balancing group selected from H, Na, K, or NH₄;
and positional isomers thereof.

21. The composition of claim 1, wherein the functionalized alkyl polyglucoside surfactant is a composition that includes a compound of the following formula: 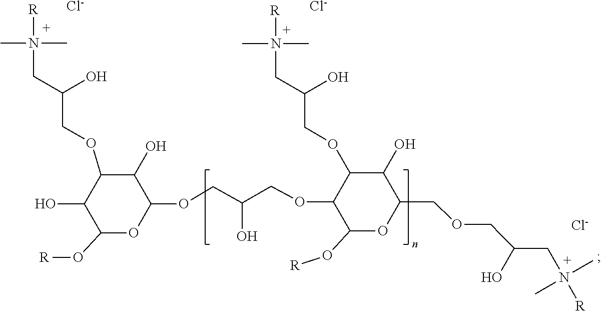
wherein R is an alkyl group having from about 8 to about 22 carbon atoms and n is an integer ranging from 4 to 6; and positional isomers thereof.

22. The composition of claim 1, wherein the functionalized alkyl polyglucoside surfactant is a composition that includes a compound of the following formula: 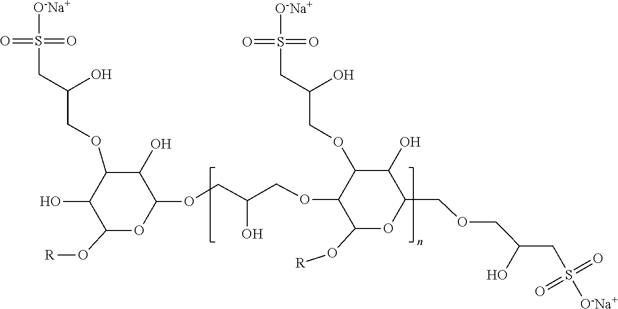
wherein R is an alkyl group having from about 8 to about 22 carbon atoms and n is an integer ranging from 4 to 6; and positional isomers thereof.

23. The composition of claim 1, wherein the functionalized alkyl polyglucoside surfactant is a composition that includes a compound of the following formula: 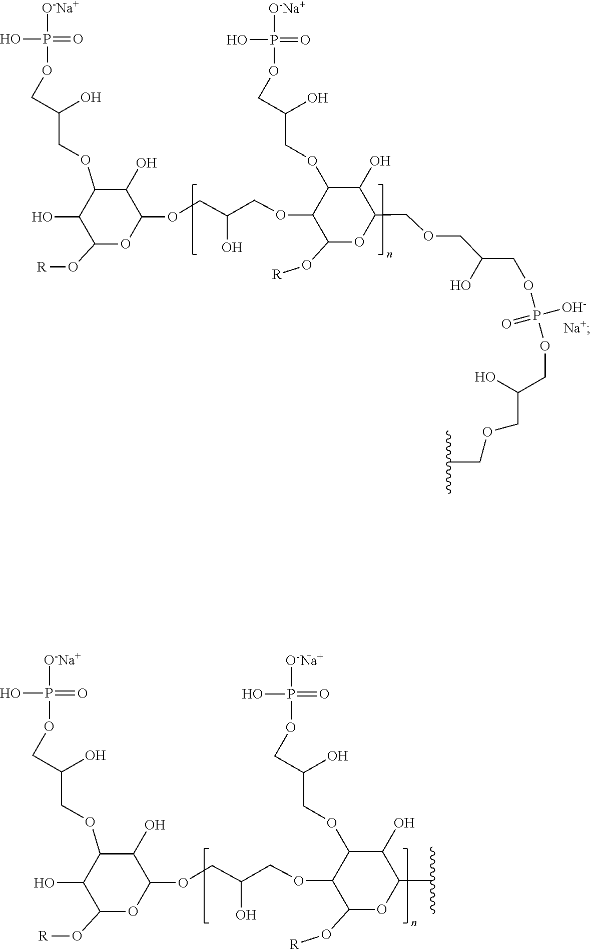
wherein R is an alkyl group having from about 8 to about 22 carbon atoms; and positional isomers thereof.

24. The composition of claim 1, wherein the functionalized alkyl polyglucoside surfactant is a composition that includes a compound of the following formula: 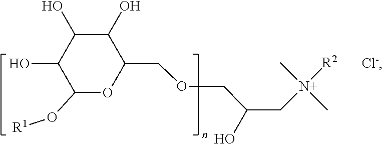
wherein R¹ is an alkyl group having from about 8 to about 22 carbon atoms, and R² is CH₃(CH₂)ₙ, and n is independently an integer from 0-21; and positional isomers thereof.

25. The composition of claim 1, wherein the functionalized alkyl polyglucoside surfactant is a composition that includes the following, as a mixture: 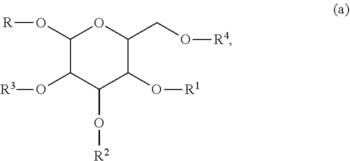
wherein
R is alkyl having 8 to 22 carbon atoms;
R¹, R², R³, and R⁴ are independently selected from —CH₂—CH(OH)—CH₂—R¹², and H, with the proviso that R¹, R², R³, and R⁴ are not all H;
R¹² is —O—C(O)—CH₂—CH(SO₃M⁺)—C(O)—O⁻M⁺
M is a charge balancing group selected from H, Na, K, or NH₄,
and 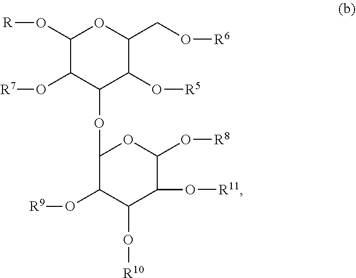
wherein
R is alkyl having 8 to 22 carbon atoms;
R⁵, R⁶, R⁷, R⁸, R⁹, R¹⁰, and R¹¹ are independently selected from —CH₂—CH(OH)—CH₂—R¹², and H,
with the proviso that R⁵, R⁶, R⁷, R⁸, R⁹, R¹⁰, and R¹¹ are not all H;
R¹² is —O—C(O)—CH₂—CH(SO₃M⁺)—C(O)—O⁻M⁺
M is a charge balancing group selected from H, Na, K, or NH₄;
and positional isomers thereof.

26. The composition of claim 1, wherein the functionalized alkyl polyglucoside surfactant is a composition that includes the following, as a mixture: 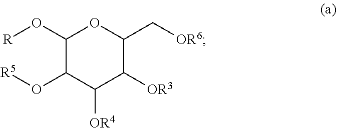
wherein one of R³, R⁴, R⁵, and R⁶ is —CH₂—C(O)—O⁻M⁺or —C(O)—CH₂—C(O)—O⁻M⁺, with the remaining R groups being H; R is alkyl having 6 to 30 carbon atoms; M is H, Na, or K; and
(b) a 1,3 dicloloro-2-propanol crosslinker;
and positional isomers thereof.

27. The composition of claim 1, wherein the functionalized alkyl polyglucoside surfactant is a composition that includes the following, as a mixture: 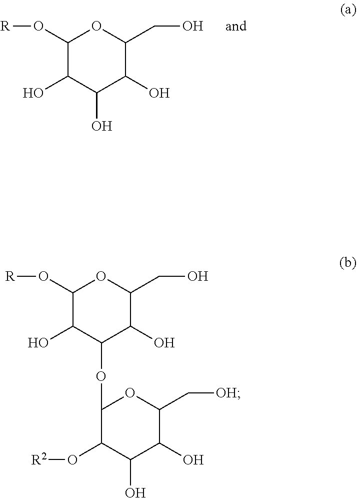
wherein R is an alkyl having 8 to 22 carbons, and R² is: 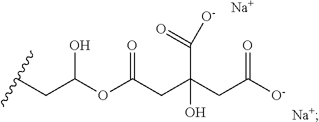
and positional isomers thereof.

28. The composition of claim 1, further comprising a co-surfactant.

29. The composition of claim 28, wherein the co-surfactant is a derivatized alkyl polyglucoside surfactant that is ethylene oxide and 1,4-dioxane

30. A process for producing a latex, comprising:
providing an aqueous solution that comprises at least one derivatized alkyl polyglucoside surfactant, water, and at least one initiator; and
introducing at least one monomer to the aqueous solution;
wherein the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

31-33. (canceled)

34. A paint composition, comprising:
an aqueous latex composition comprising:
at least one derivatized alkyl polyglucoside surfactant; wherein the derivatized alkyl polyglucoside is chosen from a carboxymethyl derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside;
water;
an emulsion polymer; and
at least one colorant or pigment.

35. The paint composition of claim 34, further comprising at least one of a rheology modifier, solvent, filler minerals, a defoamer, a neutralizing agent, a dispersant, a film formation modifier, a freeze-thaw stabilizer, and a wetting agent, and combinations thereof.
